(19) United States
(12) Patent Application Publication
(10) Pub. No.: US 2016/0292077 A1
(43) Pub. Date: Oct. 6, 2016

(54) LOW-LATENCY LOSSY PROCESSING OF MACHINE DATA

(71) Applicant: CA, Inc., New York, NY (US)

(72) Inventors: Vikul KHOSLA, Austin, TX (US); Gregory Ryan COONROD, Austin, TX (US); Sheena PATEL, Round Rock, TX (US); Mayuri Dilip MHATRE, Austin, TX (US)

(73) Assignee: CA, Inc.

(21) Appl. No.: 14/673,222

(22) Filed: Mar. 30, 2015

(51) Int. Cl. G06F 12/08

(52) U.S. Cl. CPC G06F 12/0891; G06F 2212/1024; G06F 2212/60

(57) ABSTRACT

A method includes monitoring, using a system resource monitor in a system, a plurality of system resource metrics. The system includes a ring buffer with consecutive slots, each slot corresponding to a different location in the memory. The method further includes receiving a system resource metric from the system resource monitor. The method also includes determining a first slot that is flagged as acceptable to be overwritten. If no slot is flagged as acceptable to be overwritten, the method further includes dropping the system resource metric, and the method ends. Otherwise, the method further includes storing the system resource metric in the slot and flagging that the slot is not acceptable to be overwritten. The method further includes detecting that the system resource metric was stored in the first slot, reading the system resource metric from the first slot, and flagging that the first slot is acceptable to be overwritten.

### BACKGROUND

The disclosure relates generally to cloud-based applications, and more specifically to low-latency lossy processing of machine data for system performance monitoring.

### SUMMARY

According to one embodiment of the disclosure, a method includes monitoring, using a system resource monitor in a system, a plurality of system resource metrics of the system. The system includes a ring buffer stored in a memory. The ring buffer includes a plurality of consecutive slots, each slot corresponding to a different location in the memory. The method further includes receiving, by a first thread, a system resource metric from the system resource monitor. The method also includes determining, by the first thread, a first slot that is flagged as acceptable to be overwritten. If no slot is flagged as acceptable to be overwritten, the method further includes dropping, by the first thread, the system resource metric, and the method ends. If the first slot is flagged as acceptable to be overwritten, the method further includes storing, by the first thread, the system resource metric in the first slot. The method also includes flagging, by the first thread, that the first slot is not acceptable to be overwritten. The method additionally includes detecting, by a second thread, that the system resource metric was stored in the first slot. The method further includes reading, by the second thread, the system resource metric from the first slot. The method also includes flagging, by the second thread, that the first slot is acceptable to be overwritten.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a system for low-latency lossy processing of machine data for system performance monitoring in accordance with a non-limiting embodiment of the present disclosure.

FIG. 2A illustrates a flow chart of the steps of the method by a first thread for low-latency lossy processing of machine data for system performance monitoring performed in accordance with a non-limiting embodiment of the present disclosure.

FIG. 2B illustrates a flow chart of the steps of the method by a second thread for low-latency lossy processing of machine data for system performance monitoring performed in accordance with a non-limiting embodiment of the present disclosure.

FIG. 3 illustrates an example of low-latency lossy processing of machine data for system performance monitoring in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Cloud applications often depend on just-in-time resource allocation to provide demand-driven scaling and performance to consumers and to minimize costs. As consumer demand grows, cloud applications must be able to scale to meet that demand, consuming significantly more computing resources in a short period of time. To accommodate such demand, some systems simply have a large number of computing resources standing by to support any sudden increase in demand that the cloud applications may experience. But this approach is expensive since resources idle whenever demand is not high.

Thus, to minimize costs and maximize economy, many systems implement a just-in-time resource allocation approach that provides that only the number of resources necessary to meet consumer demand are allocated as the cloud application grows. Many systems utilize dynamic and ethereal resources to achieve the level of elasticity required for this scalability. By implementing the just-in-time approach, the system can achieve both low costs and high performance.

System administrators typically use instrumentation and resource monitoring tools to monitor cloud applications and associated resources as the applications grow. Similarly, software developers also use these tools to implement and test cloud-based solutions. As the cloud applications scale with demand, these tools provide performance metrics to administrators, which help them manage the system's performance and ensure that the applications continue to perform at peak levels during the high-demand times.

But just-in-time resource allocation presents a challenge for system administrators attempting to use instrumentation and resource monitoring tools to monitor the system's performance. As demand increases and the cloud application scales, more and more performance metrics are sent back through the monitoring tools to the system administrator. While the performance metrics give the administrator crucial information as to how the system is performing in near-real time, the metrics can also consume valuable resources that the system has already allocated to the cloud application itself. Because the just-in-time approach has the system allocate only the resources the cloud application itself must use, there may not be enough resources to share with the monitoring tools sending its multitude of performance metrics. In this case, the performance metrics can cause the entire system to throw errors or otherwise impact the system's overall performance. For example, the flood of incoming performance metrics may overload the system and cause the entire system to shut down or stop working.

In order to achieve minimal resource impact while still providing rich resource consumption data, certain embodiments of the present disclosure utilizes a ring buffer of pre-allocated objects and producer and consumer thread processes, which write to and read from the buffer. The pre-allocated buffer helps maintain a stable memory footprint while also reducing the amount of garbage collection necessary. This allows for the aggregation of system resource data from an arbitrary number of system nodes without impacting the application's overall performance.

During normal operation, the Event Producer (writer) receives system resource metrics from the system resource monitor and writes them to open slots on the ring buffer. The Event Consumer (reader) watches for new entries on the ring buffer and processes them after they appear. The Event Consumer then aggregates the incoming system metrics based on user-defined batching parameters and passes them to an external database for storage. As long as the Event Consumer is able to keep pace with the Event Producer, no data loss can occur. In the case where the Event Producer catches up to the Event Consumer and attempts to write to the ring buffer slot currently being consumed, the Event Producer will drop the incoming events until a new slot becomes available. While this does result in data loss, it also ensures that no system resource contention or buffer overflow occurs. Accordingly, the use of instrumentation and resource monitoring tools does not impact the performance of the host cloud application.

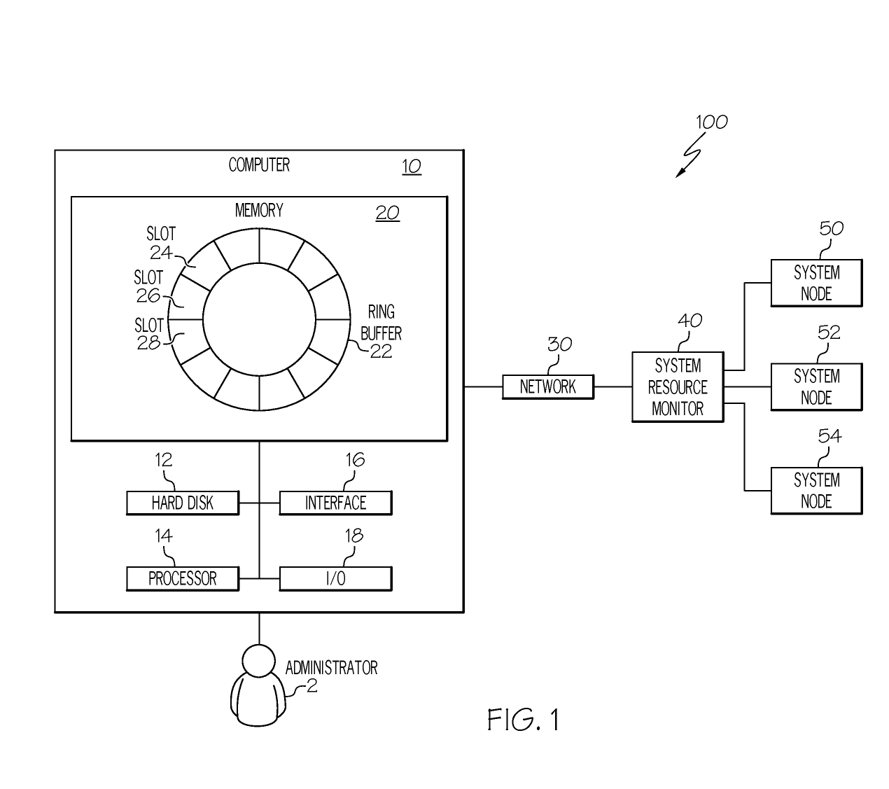

With reference to FIG. 1, a system 100 for low-latency lossy processing of machine data for system performance monitoring is illustrated in accordance with a non-limiting embodiment of the present disclosure. In its preferred embodiment, system 100 is a cloud-based computing system. System 100 includes computer 10, system resource monitor 40, and system nodes 50, 52, and 54, which are all connected via network 30. Administrator 2 uses computer 10. Computer 10 includes memory 20, hard disk 12, processor 14, interface 16, and I/O 18. Memory 20 stores ring buffer 22. Ring buffer may be allocated in real-time or may be pre-allocated in memory 20. Ring buffer 22 has a series of consecutive slots, for example slots 24, 26, and 28. Each of slots 24, 26, and 28 correspond to a different location in memory 20. Processor 14 loads instructions from hard disk 12 and executes them in memory 20. System resource monitor 40 is installed in system 100, which monitors system 100, including for example system nodes 50, 52, and 54, for system resource metrics. System resource metrics may indicate a performance level or other attribute of one or more components of system 100, including for example the performance levels of system nodes 50, 52, or 54. As an example, system resource metrics may include: disk access signs, disk TOPS (“Input/Output Operations Per Second), or application performance metrics indicating the real-time performance of the CPU, memory, system load, or network, among others. System resource monitor 40 sends each system resource metric that it collects over network 30 to computer 10.

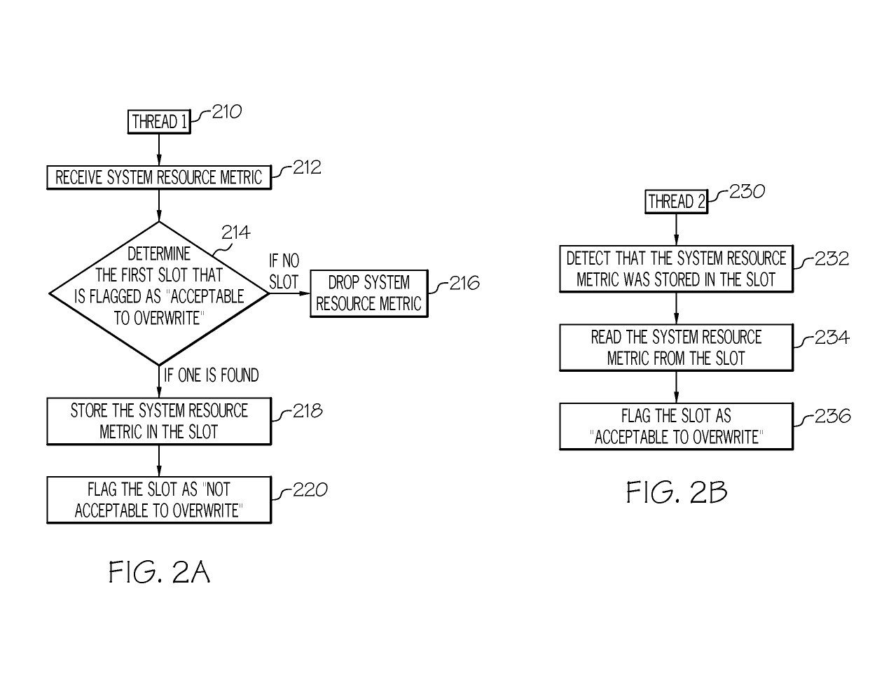

With reference to FIG. 2A, a flow chart of the steps of the method performed by a first thread for low-latency lossy processing of machine data for system performance monitoring is illustrated in accordance with a non-limiting embodiment of the present disclosure. First thread 210 iteratively performs a series of steps. First thread 210 may be, for example, an Event Producer or writer thread. At step 212, first thread 210 receives a system resource metric from system resource monitor 40 indicating the performance of one or more system nodes 50, 52, and 54.

At step 214, first thread 210 determines the first slot in ring buffer 22 that is flagged as acceptable to overwrite. First thread 210 keeps track of what slot in ring buffer 22 it last wrote to, and may determine the first slot that is flagged as acceptable to overwrite by checking whether the next consecutive slot has been written to. If the next consecutive slot has been flagged as not acceptable to overwrite, then first thread 210 moves to the next consecutive slot, repeating this process until there are no more slots in ring buffer 22. If no slot in ring buffer 22 is flagged as acceptable to overwrite, first thread 210 drops the system resource metric at step 216 and the method ends. In particular embodiments, first thread 210 also alerts system administrator 2 that system 100 is dropping the system resource metric. For example, first thread 210 may display the alert through interface 16 of computer 10 to system administrator 2. The alert may include a warning, alarm, or any other means of alerting the administrator.

In particular embodiments, first thread 210 does not drop the system resource metric at all, but rather writes the system resource metric onto ring buffer 22 whether or not the slot is acceptable to be overwritten. This scenario may result in a more lossy system, but ring buffer 22 still does not throw any errors because the previous unread data is merely overwritten, and the buffer can never be overfull.

If first thread 210 successfully determines a first slot that is flagged as acceptable to overwrite, first thread 210 stores the system resource metric in that first slot at step 218. For example, if slot 24 is flagged as not acceptable to overwrite, but slot 26 is flagged as acceptable to overwrite, then first thread 210 stores the system resource metric in slot 26.

Once first thread 210 stores the system resource metric in the first slot at step 218, first thread 210 then flags the first slot as not acceptable to overwrite. For example, if first thread 210 stores the system resource metric in slot 26, then first thread 210 flags slot 26 as not acceptable to overwrite. This signals to system 100 that no other metric should be written in that slot of ring buffer 22 until the second thread can read off the metric. This may prevent system 100 from throwing an error or otherwise having its performance impacted. First thread 210 follows this general process for each system resource metric it receives from system resource monitor 40.

With reference to FIG. 2B, a flow chart of the steps of the method performed by a second thread for low-latency lossy processing of machine data for system performance monitoring is illustrated in accordance with a non-limiting embodiment of the present disclosure. Second thread 230 iteratively performs a series of steps. Second thread 230 may be, for example, an Event Consumer or reader thread. Second thread 230 monitors ring buffer 22 for any system resource metrics that are stored in its slots. At step 232, second thread 230 detects that a system resource metric was stored in a slot on ring buffer 22. For example, second thread 230 may detect that the system resource metric in the example above was written by first thread 210 in slot 26 of ring buffer 22.

Once second thread 230 detects that a system resource metric was stored in a slot of ring buffer 22, second thread 230 reads the system resource metric from the slot at step 234. For example, if second thread 230 detects that the system resource metric was stored in slot 26 of ring buffer 22, second thread 230 reads the system resource metric from slot 26.

Once second thread 230 reads the system resource metric from the slot at step 234, second thread 230 flags the slot as acceptable to overwrite at step 236. For example, if second thread 230 detects that the system resource metric was stored in slot 26 of ring buffer 22, and second thread 230 reads the system resource metric from slot 26, second thread 230 then flags slot 26 as acceptable to overwrite. This indicates to system 100 that it is acceptable to write to that slot of ring buffer 22 again, as the metric has been read off and sent for processing. As long as the Event Consumer or reading thread can keep up with the Event Producer or writing thread, no data loss can occur. When so many performance metrics are being sent to ring buffer 22 that the Event Consumer second thread cannot keep up, system 100 does become lossy, but the data loss prevents system 100 from throwing an error or consuming too many valuable resources that the cloud application needs. In this case, it may be more important to system administrator 2 that the cloud application retain its resources to be able to scale with increased demand than have all of the performance metrics sent without disruption.

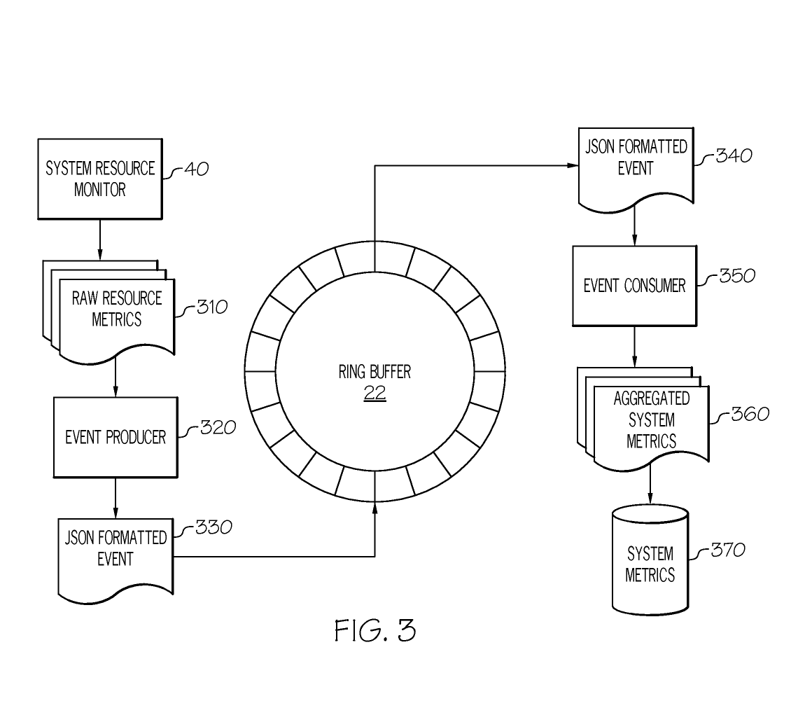

With reference to FIG. 3, an example of low-latency lossy processing of machine data for system performance monitoring is illustrated in accordance with a non-limiting embodiment of the present disclosure. In accordance with the above-described process, system resource monitor 40 sends system resource metrics about the performance of system 100, for example system nodes 50, 52, and 54, in near-real time. System resource monitor 40 may take the form of a data collector and may continuously monitor system 100 for the system resource metrics, or may poll system 100 at pre-determined time intervals, for example every 5 to 10 seconds. In particular embodiments, system resource monitor 40 may reside on a server with an interface to system administrator 2. System resource monitor 40 may write on every instance of an application to monitor its performance.

System resource monitor 40 may send raw system resource metrics 310 to a first thread, e.g., Event Producer 320. System resource monitor 40 may send the raw system resource metrics 310 by broadcasting the data over network 30 or shooting the data at its target in the ether. Event Producer 320 may receive the raw system resource metrics, for example by listening for raw HTTP traffic that system resource monitor 40 sent over network 30. In particular embodiments, Event Producer 320 may write the raw system resource metric directly onto ring buffer 22. In alternate embodiments, Event Producer 320 may package the raw system resource metric that is currently in the form of raw HTTP traffic into a raw JAVA® object. In so doing, Event Producer 320 may standardize the form that the system resource metric takes and may strip away any unnecessary information that was included in the raw HTTP traffic. In certain embodiments, Event Producer 320 may directly write the JAVA® object onto ring buffer 22. In other embodiments, Event Producer 320 may put the system resource metric that is currently in the form of a JAVA® object into a JSON formatted event box 330. Use of a JSON formatted event box may provide the added advantage of being easier for system 100 to parse. JSON formatted event box 330 is a container that wraps the raw JAVA® object with information. JSON formatted event box 330 thus includes both the JAVA® object and additional standardizing information, including timing and header information. In these embodiments, Event Producer 320 writes JSON formatted event box 330 onto ring buffer 22.

When the second thread—e.g., Event Consumer 350—detects that a system resource metric has been stored on ring buffer 22, Event Consumer 350 reads the system resource metric off of ring buffer 22. In certain embodiments, Event Consumer 350 reads a raw system resource metric directly off of ring buffer 22. In alternate embodiments, Event Consumer 350 reads the system resource metric off in the form of JSON formatted event box 340. JSON formatted event box 330 is the same as JSON formatted event box 340 in form and content. In these embodiments, Event Consumer 350 unpacks JSON formatted event box 340 into a JAVA® object. In other embodiments, Event Consumer 350 reads a JAVA® object containing the raw system resource metric directly off of ring buffer 22.

In particular embodiments, Event Consumer 350 stores the JAVA® object containing the system resource metric into one or more databases of system metrics 370. In other embodiments, Event Consumer 350 first unpacks the JAVA® object into a raw system metric, then stores the raw system metric into the database of system metrics 370. In certain embodiments, Event Consumer 350 may fire off the raw system metric into HTTP traffic. In particular embodiments, the Event Consumer 350 aggregates a plurality of system metrics into aggregated system resource metrics 360, and stores the aggregated system resource metrics 360 into a database of system metrics 370. Instead of or in addition to directly storing the individual or aggregated system resource metrics into a database for future use, the individual or aggregated system metrics may be displayed in some form to the administrator 2, for example through interface 16 on computer 10. System administrator 2 may thus be able to use the performance metric to manage the performance of system 100 as the cloud application grows with demand.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
monitoring, using a system resource monitor in a system, a plurality of system resource metrics of the system, the system comprising a ring buffer stored in a memory, wherein the ring buffer is comprised of a plurality of consecutive slots, each slot corresponding to a different location in the memory;
receiving, by a first thread, one of the plurality of system resource metrics from the system resource monitor;
determining, by the first thread, a first slot of the plurality of slots that is flagged as acceptable to be overwritten;
if no slot is flagged as acceptable to be overwritten, dropping, by the first thread, the system resource metric; and
if the first slot is flagged as acceptable to be overwritten:
storing, by the first thread, the system resource metric in the first slot;
flagging, by the first thread, that the first slot is not acceptable to be overwritten;
detecting, by a second thread, that the system resource metric was stored in the first slot;
reading, by the second thread, the system resource metric from the first slot; and
flagging, by the second thread, that the first slot is acceptable to be overwritten.

2. The method of claim 1, further comprising:
aggregating, by the second thread, the plurality of system resource metrics read from the ring buffer; and
storing, by the second thread, the aggregated system resource metrics into a database.

3. The method of claim 1,
wherein storing the system resource metric in the first slot comprises:
packaging a raw form of the system resource metric into an object form of the system resource metric;
packaging the object form of the system resource metric into an event form of the system resource metric; and
storing the event form of the system resource metric in the first slot; and,
wherein reading the system resource metric from the first slot comprises:
reading the event form of the system resource metric from the first slot;
unpackaging the event form of the system resource metric into the object form of the system resource metric; and
unpackaging the object form of the system resource metric into the raw form of the system resource metric.

4. The method of claim 1, wherein, if no slot is flagged as acceptable to be overwritten, the method further comprises alerting a system administrator that the system is dropping the system resource metric.

5. The method of claim 1, wherein the system is a cloud-based computing system.

6. The method of claim 1, wherein the ring buffer is pre-allocated in the memory.

7. The method of claim 1, wherein each system resource metric of the plurality of system resource metrics indicates a performance level of a component of the system.

8. A computer configured to access a storage device, the computer comprising:
a processor; and
a non-transitory, computer-readable storage medium storing computer-readable instructions that when executed by the processor cause the computer to perform:
monitoring, using a system resource monitor in a system, a plurality of system resource metrics of the system, the system comprising a ring buffer stored in a memory, wherein the ring buffer is comprised of a plurality of consecutive slots, each slot corresponding to a different location in the memory;
receiving, by a first thread, one of the plurality of system resource metrics from the system resource monitor;
determining, by the first thread, a first slot of the plurality of slots that is flagged as acceptable to be overwritten;
if no slot is flagged as acceptable to be overwritten, dropping, by the first thread, the system resource metric; and
if the first slot is flagged as acceptable to be overwritten:
storing, by the first thread, the system resource metric in the first slot;
flagging, by the first thread, that the first slot is not acceptable to be overwritten;
detecting, by a second thread, that the system resource metric was stored in the first slot;
reading, by the second thread, the system resource metric from the first slot; and
flagging, by the second thread, that the first slot is acceptable to be overwritten.

9. The computer of claim 8, wherein the computer-readable instructions further cause the computer to perform:
aggregating, by the second thread, the plurality of system resource metrics read from the ring buffer; and
storing, by the second thread, the aggregated system resource metrics into a database.

10. The computer of claim 8,
wherein storing the system resource metric in the first slot comprises:
packaging a raw form of the system resource metric into an object form of the system resource metric;
packaging the object form of the system resource metric into an event form of the system resource metric; and
storing the event form of the system resource metric in the first slot; and,
wherein reading the system resource metric from the first slot comprises:
reading the event form of the system resource metric from the first slot;
unpackaging the event form of the system resource metric into the object form of the system resource metric; and
unpackaging the object form of the system resource metric into the raw form of the system resource metric.

11. The computer of claim 8, wherein, if no slot is flagged as acceptable to be overwritten, the computer-readable instructions further cause the computer to perform alerting a system administrator that the system is dropping the system resource metric.

12. The computer of claim 8, wherein the system is a cloud-based computing system.

13. The computer of claim 8, wherein the ring buffer is pre-allocated in the memory.

14. The computer of claim 8, wherein each system resource metric of the plurality of system resource metrics indicates a performance level of a component of the system.

15. A computer program product comprising:
a computer-readable storage medium having computer-readable program code embodied therewith, the computer-readable program code comprising:
computer-readable program code configured to monitor, using a system resource monitor in a system, a plurality of system resource metrics of the system, the system comprising a ring buffer stored in a memory, wherein the ring buffer is comprised of a plurality of consecutive slots, each slot corresponding to a different location in the memory;
computer-readable program code configured to receive, by a first thread, one of the plurality of system resource metrics from the system resource monitor;
computer-readable program code configured to determine, by the first thread, a first slot of the plurality of slots that is flagged as acceptable to be overwritten;
computer-readable program code configured to, if no slot is flagged as acceptable to be overwritten, drop, by the first thread, the system resource metric; and
computer-readable program code configured to, if the first slot is flagged as acceptable to be overwritten:
store, by the first thread, the system resource metric in the first slot;
flag, by the first thread, that the first slot is not acceptable to be overwritten;
detect, by a second thread, that the system resource metric was stored in the first slot;
read, by the second thread, the system resource metric from the first slot; and
flag, by the second thread, that the first slot is acceptable to be overwritten.

16. The computer program product of claim 15, further comprising computer-readable program code configured to:
aggregate, by the second thread, the plurality of system resource metrics read from the ring buffer; and
store, by the second thread, the aggregated system resource metrics into a database.

17. The computer program product of claim 15,
wherein storing the system resource metric in the first slot comprises:
packaging a raw form of the system resource metric into an object form of the system resource metric;
packaging the object form of the system resource metric into an event form of the system resource metric; and
storing the event form of the system resource metric in the first slot; and,
wherein reading the system resource metric from the first slot comprises:
reading the event form of the system resource metric from the first slot;
unpackaging the event form of the system resource metric into the object form of the system resource metric; and
unpackaging the object form of the system resource metric into the raw form of the system resource metric.

18. The computer program product of claim 15, wherein, if no slot is flagged as acceptable to be overwritten, the computer program product further comprises computer-readable program code configured to alert a system administrator that the system is dropping the system resource metric.

19. The computer program product of claim 15, wherein the system is a cloud-based computing system.

20. The computer program product of claim 15, wherein the ring buffer is pre-allocated in the memory.
